(19) United States
(12) Patent Application Publication
(10) Pub. No.: US 2016/0156075 A1
(43) Pub. Date: Jun. 2, 2016

(54) COOLING SYSTEM AND METHOD

(71) Applicant: SANDVIK MINING AND CONSTRUCTION OY, Tampere (FI)

(72) Inventor: Kari LINDHOLM, Tampere (FI)

(21) Appl. No.: 14/953,072

(22) Filed: Nov. 27, 2015

(30) Foreign Application Priority Data
Nov. 27, 2014 (EP) 14195058.4

(51) Int. Cl. H01M 10/659; E21C 35/00; H01M 10/6556; F28D 15/02; H01M 10/613; H01M 10/625

(52) U.S. Cl. CPC H01M 10/659; H01M 10/613; H01M 10/625; H01M 10/6556; F28D 15/0275; E21C 35/00; H01M 2220/20

(57) ABSTRACT

A battery cooling system of an electric mining machine includes lines arranged to communicate with a battery to be cooled for transferring heat energy from the battery to coolant within the fluid lines, a coolant cartridge receiver, and a coolant cartridge having a capacity for receiving and storing heat energy. The coolant cartridge is removably arrangeable in the coolant cartridge receiver and the fluid lines are connected to the coolant cartridge receiver for transferring heat energy from the coolant within the fluid lines to the coolant cartridge arranged in the coolant cartridge receiver. The disclosure also relates to an electric mining machine, a refrigeration arrangement of an electric mining machine, and a method for cooling a battery of an electric mining machine.

### RELATED APPLICATION DATA

This application claims priority under 35 U.S.C. §119 to EP Patent Application No. 14195058.4, filed on Nov. 27, 2015, which the entirety thereof is incorporated herein by reference.

### BACKGROUND

The present disclosure relates to a battery cooling system of an electric mining machine and an electric mining machine. The disclosure still further relates to a refrigeration arrangement of an electric mining machine and to a method for cooling a battery of an electric mining machine.

A battery for storing electrical energy should be operated in a temperature range that supports a long lifetime of the battery. When a battery is charged electrical energy is stored to the battery for later use. When the energy stored to the battery is used to supply power to an appliance, e.g. an electrical motor, the battery is discharged.

A typical operating temperature for a lithium-ion battery is between 0-45° C. If the temperature exceeds 45° C., the battery may be degraded. When the temperature of the battery is higher than 45° C., electrolyte inside the battery starts to degrade, which may cause pressure inside battery cells. The pressure may accumulate inside the battery and it may be discharged from the battery along with the electrolyte, whereby personnel and equipment nearby the battery may be in danger.

Therefore, there is a demand for systems and methods for cooling batteries.

### SUMMARY

According to a first aspect, there is provided a battery cooling system of an electric mining machine, including fluid lines arranged to communicate with a battery to be cooled for transferring heat energy from the battery to coolant within the fluid lines, a coolant cartridge receiver, and a coolant cartridge having a capacity for receiving and storing heat energy. The coolant cartridge is removably arranged in the coolant cartridge receiver, wherein the fluid lines are connected to the coolant cartridge receiver for transferring heat energy from the coolant within the fluid lines to the coolant cartridge arranged in the coolant cartridge receiver. Thereby a simple cooling system may be achieved.

According to a further aspect, there is provided an electric mining machine having at least one battery for operating the mining machine, and a battery cooling system for cooling the at least one battery. Thereby a simple and small sized structure of cooling may be achieved.

According to a further aspect, there is provided a refrigeration arrangement for cooling the coolant cartridge of the battery cooling system including a refrigeration device arranged to removably receive the coolant cartridge, and to reduce the heat energy content of the coolant cartridge.

According to a further aspect, there is provided a method for cooling a battery of an electric mining machine, including the steps of cooling a coolant cartridge, arranging the cooled coolant cartridge in a coolant cartridge receiver, transferring heat energy created by the function of the battery to the coolant cartridge over the coolant cartridge receiver, thus storing the heat energy in the coolant cartridge by adding heat energy contained therein, and removing the coolant cartridge and heat energy stored therein from the coolant cartridge receiver. Accordingly, a low cost method for cooling the battery may be achieved.

In one embodiment the coolant cartridge includes a room arranged to contain receiving material for receiving heat energy from the coolant within the fluid lines. An advantage is that a cheap and/or high capacity liquid material, e.g. water can be used.

In one embodiment the capacity of the coolant cartridge for receiving heat energy is at least partly based on phase transition of the receiving material. An advantage is that the capacity for receiving heat energy may be very high.

In one embodiment the receiving material includes salt, wherein the capacity for receiving heat energy may be very high.

In one embodiment the coolant cartridge includes receiving material in solid state, reducing leaking problems.

In one embodiment the coolant cartridge has a capacity of storing at least 4 kWh of heat energy, such capacity is usually enough for cooling the battery for a single charging interval.

In one embodiment the refrigeration arrangement is arranged in a battery charging station of the battery enabling easy and quick handling of the coolant cartridge while the battery is being charged.

The foregoing summary, as well as the following detailed description of the embodiments, will be better understood when read in conjunction with the appended drawings. It should be understood that the embodiments depicted are not limited to the precise arrangements and instrumentalities shown.

### BRIEF DESCRIPTION OF FIGURES

Some embodiments illustrating the present disclosure are described in more detail in the attached drawings, in which

FIG. 1 is a schematic side view of a battery cooling system in partial cross-section.

FIG. 2 is a schematic side view of a coolant cartridge in partial cross-section.

FIG. 3 is a schematic view of an electric mining machine and a refrigeration arrangement.

In the figures, some embodiments are shown simplified for the sake of clarity. Similar parts are marked with the same reference numbers in the figures.

### DETAILED DESCRIPTION

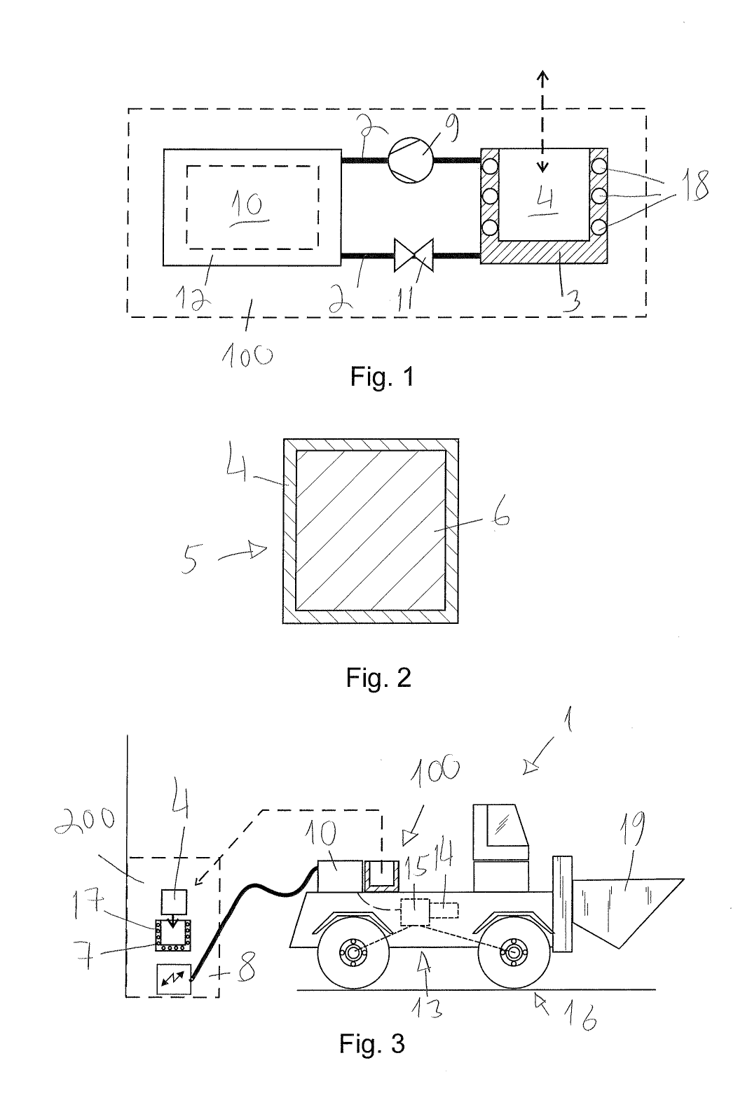

FIG. 1 is a schematic side view of an example battery cooling system in partial cross-section, and FIG. 2 is a schematic side view of an example coolant cartridge in partial cross-section.

The battery cooling system 100 includes fluid lines 2 that are arranged to communicate with a battery 10 to be cooled. It is to be noted that the battery 10 is depicted by dashed lines in FIG. 1. Furthermore, it is to be noted that the battery 10 may have one or more batteries that can be coupled in series or in parallel.

The fluid lines 2 are filled with coolant that receives heat energy generated in the battery 10. The heat energy is transferred by the coolant to a coolant cartridge receiver 3.

The coolant may be e.g. water or water-alcohol mixture, such as water-glycol or water-ethanol mixture, salt water, liquid salt, oil or other heat transfer fluid.

The battery cooling system 100 may include a battery cooler 12 positioned in contact with the battery such that heat energy may be conducted from the battery 10 to battery cooler 12. The battery cooler 12 may have fluid channels that are connected to the fluid lines 2. In another embodiment, the fluid channels of the battery cooler 12 are not connected to the fluid lines 2 but there is a heat exchanger arranged to transfer heat energy. In still another embodiment, the battery cooler 12 does not have any fluid channels, but heat energy is transferred to the fluid lines 2 by solid structure of the battery cooler 12.

The fluid lines 2 are connected to the battery cooler 12 for removing the heat energy therefrom for feeding cooled coolant back in the battery cooler 12.

The coolant cartridge receiver 3 may receive a coolant cartridge 4. The coolant cartridge 4 includes a receiving material 6 that may receive heat energy from the coolant cartridge receiver 3 and is capable to store the heat energy therein.

The coolant cartridge receiver 3 may include fluid channels 18 connected to the fluid lines 2. In the fluid channels 18 there may be e.g. water or water-alcohol mixture, such as water-glycol or water-ethanol mixture, salt water, liquid salt, oil or other heat transfer fluid.

In another embodiment, the fluid channels 18 are not connected to the fluid lines 2, but there is a heat exchanger arranged to transfer heat energy between the fluid lines 2 and the fluid channels 18. In still another embodiment, the coolant cartridge receiver 3 does not include any fluid channels, but heat energy is transferred by the solid structure of the coolant cartridge receiver 3 from the fluid lines 2 to the coolant cartridge 4.

The coolant cartridge 4 is removably arranged or attached to the coolant cartridge receiver 3. Accordingly, the coolant cartridge 4 can be easily removed from the receiver 3. Especially, there are no fluid line connections between the receiver 3 and the coolant cartridge 4.

The battery cooling system 100 may include means for controlling the cooling operation, such as one or more pumps 9 for circulating the coolant, and valves 11 for controlling the flow of the coolant, etc.

As shown in FIG. 2, the coolant cartridge 4 may have a room 5 and receiving material 6 arranged therein. The receiving material 6 has capability for receiving heat energy from the coolant running within the fluid lines 2. According to an idea, the receiving material 6 includes liquid, e.g. water or oil. According to another idea, the receiving material 6 is material 6 in solid state, e.g. salt or metal.

In an embodiment, the capacity of the coolant cartridge 4 for receiving heat energy is, at least partly, based on phase transition of the receiving material 6. For example, if the receiving material 6 is water, a phase transition from solid or icy state to liquid state may take place due to the received heat energy.

FIG. 3 is a schematic view of a mining machine and a refrigeration arrangement.

The mining machine 1 is a battery powered vehicle and therefore, it includes a battery 10. The battery 10 may be capable of storing electrical energy to be supplied to one or more functions of the vehicle. The electrical energy from the battery 10 may be used to power transportation of goods and/or people by the mining machine 1. In an embodiment the battery may be lithium-ion battery.

The mining machine 1 includes at least one battery 10 and a battery cooling system 100, the function and the construction being discussed in connection with FIGS. 1 and 2 above. It is to be noted here that the mining machine may comprise multiple coolant cartridge receivers 3.

Preferably, the battery cooling system 100 has a cooling power that is sufficient to cool the battery 10 all that time the battery 10 is discharged and is supplying electrical power to power operations of the mining machine 1.

The mining machine 1 may be moved by means of drive equipment 13. The drive equipment 13 may include one or more drive motors 14 and one or more power transmission means 15 for transmitting drive power to one or more driving means 16, e.g. wheels.

The power transmission means 15 may have a mechanical gear system and mechanical power transmission members or, alternatively, a hydraulic or electric drive power system may be used.

The drive equipment 13 may be connected to the battery 10 for supplying electricity to the drive equipment 13 from the battery 10. The connection may include an electrically conductive cable, shown by a dashed line in the FIG. 3 between the battery 10 and the drive equipment 13. Accordingly, the movement of the mining machine 1 may be powered by electricity from the battery 10. It should be appreciated that the mining machine 1 may have also other power sources in addition to the battery 10.

The battery powered mining machine 1 may be, for example, a dumper, load haul dump, loader, drilling device, rock drilling rig or any other mining vehicle. The mining vehicle 1 may be equipped with one or more mining work devices which mining work device may be one or more of the following mining work devices: rock drilling machine, bolting machine, scaling device, injection device, blasthole charger, loading device, bucket, box, measuring device, or drilling, sealing and propellant feeding equipment used in small-charge excavation. The battery powered mining machine 1 shown in FIG. 3 includes a dump 19 for production operations of the mining machine 1.

The productive operations may be driven by the drive equipment 13. Therefore, the productive operations may be powered by the battery 10.

FIG. 3 is also showing a refrigeration arrangement 200 that is equipped with means for cooling the coolant cartridge 4 of the battery cooling system 100 described in this description.

The refrigeration arrangement 200 includes a refrigeration device 7 onto or into which the coolant cartridge 4 removed from the mining machine 1 may be arranged.

The refrigeration device 7 receives heat energy from the heated coolant cartridge 4 and thus reduces the heat energy content of the coolant cartridge 4, i.e. the coolant cartridge 4 cools down. The refrigeration device 7 is basically a heat exchanger. The refrigeration device 7 may have refrigeration fluid channels 17 that are arranged to receive heat energy from the refrigeration device 7 and, furthermore, arranged to transfer heat energy away from the refrigeration device 7. The heat energy may be transferred from the refrigeration fluid channels 17 e.g. into air or another liquid by a heat exchanger not shown in Figures. The refrigeration fluid channels 17 may contain e.g. water or water-alcohol mixture, such as water-glycol or water-ethanol mixture, salt water, liquid salt, oil or other heat transfer fluid.

In another embodiment, the refrigeration device 7 does not have any fluid channels, but heat energy is transferred by its solid structure away from the coolant cartridge receiver 3.

In those embodiments of the coolant cartridge 4 wherein the coolant cartridge 4 includes receiving material 6 that has stored heat energy by phase transition, the reduction of the heat energy content of the coolant cartridge 4 in the refrigeration device 7 includes a reverse phase transition of the receiving material 6.

In the embodiment shown in FIG. 3, the refrigeration arrangement 200 is arranged in a battery charging station 8 meant for charging the battery 10 of the mining machine 1. Thus, the refrigeration arrangement 200 may be easily and quickly accessed when the battery 10 of the mining machine 1 is to be charged. In order to rationalize even more the use of the battery cooling system 100 and the refrigeration arrangement, the cooling capacity of the coolant cartridge 4 is chosen to be sufficient to cool the battery 10 for a single charging interval of the battery 10.

It is to be noted, however, that it is not essential to arrange the refrigeration arrangement 200 in a battery charging station 8.

The coolant cartridge 4 is kept in the refrigeration device 7 until it has reached a predetermined cooling capacity. The cooling capacity of the coolant cartridge 4 may be measured and/or monitored based on e.g. temperature measurements known per se. In an embodiment, the cooling capacity is at least 4 kWh. The operating temperature of the coolant cartridge 4 is in range between +10 to −100° C.

The capacity of the refrigeration device 7 is high enough for cooling the coolant cartridge 4 in the predetermined cooling capacity when the battery 10 is recharged.

The refrigeration arrangement 200 may have a plurality of refrigeration devices 7. Thus, plurality of coolant cartridges 4 can be cooled simultaneously for use in plurality of mining machines 1. According to an idea, all of the plurality of refrigeration devices 7 and the coolant cartridges 4 are identical. Thus, any of the plurality of refrigeration devices 7 is able to receive a coolant cartridge 4 from any of the plurality of mining machines 1, and any of the coolant cartridges 4 may be arranged in any of the plurality of mining machines 1.

In summary, the battery 10 may be cooled by method that includes steps of:

cooling the coolant cartridge 4 in the refrigeration device 7,

removing the coolant cartridge 4 from the refrigeration device 7 and arranging it in the coolant cartridge receiver 3 in the mining machine 1,

transferring heat energy created by the function of the battery 10 to the coolant cartridge 4 over the coolant cartridge receiver 3,

thus storing the heat energy in the coolant cartridge 4 by adding heat energy contained therein,

removing the heated coolant cartridge 4 and heat energy stored therein from the coolant cartridge receiver 3, and

arranging the heated coolant cartridge 4 in the refrigeration device 7 for re-cooling.

The invention is not limited solely to the embodiments described above, but instead many variations are possible within the scope of the inventive concept defined by the claims below. Within the scope of the inventive concept the attributes of different embodiments and applications can be used in conjunction with or replace the attributes of another embodiment or application.

The drawings and the related description are only intended to illustrate the idea of the invention. The invention may vary in detail within the scope of the inventive idea defined in the following claims.

What is claimed is:

1. A battery cooling system of an electric mining machine, comprising:
fluid lines arranged to communicate with a battery to be cooled for transferring heat energy from the battery to coolant within the fluid lines;
a coolant cartridge receiver; and
a coolant cartridge having a capacity for receiving and storing heat energy, the coolant cartridge being removably arrangeable in the coolant cartridge receiver, wherein the fluid lines are connected to the coolant cartridge receiver for transferring heat energy from the coolant within the fluid lines to the coolant cartridge arranged in the coolant cartridge receiver.

2. The battery cooling system as claimed in claim 1, wherein the coolant cartridge includes a room arranged to contain receiving material for receiving heat energy from the coolant within the fluid lines.

3. The battery cooling system as claimed in claim 2, wherein the capacity of the coolant cartridge for receiving heat energy is at least partly based on phase transition of the receiving material.

4. The battery cooling system as claimed in claim 2, wherein the receiving material includes water.

5. The battery cooling system as claimed in claim 2, wherein the receiving material includes salt.

6. The battery cooling system as claimed in claim 1, wherein the coolant cartridge includes receiving material in solid state.

7. The battery cooling system as claimed in claim 1, wherein the coolant cartridge has a capacity of storing at least 4 kWh of heat energy.

8. An electric mining machine comprising:
at least one battery for operating the mining machine; and
a battery cooling system for cooling the at least one battery, the battery cooling system including fluid lines arranged to communicate with a battery to be cooled for transferring heat energy from the battery to coolant within the fluid lines, a coolant cartridge receiver, and a coolant cartridge having a capacity for receiving and storing heat energy, the coolant cartridge being removably arrangeable in the coolant cartridge receiver, wherein the fluid lines are connected to the coolant cartridge receiver for transferring heat energy from the coolant within the fluid lines to the coolant cartridge arranged in the coolant cartridge receiver.

9. A method for cooling a battery of an electric mining machine, comprising:
cooling a coolant cartridge;
arranging the cooled coolant cartridge in a coolant cartridge receiver;
transferring heat energy created by the function of the battery to the coolant cartridge over the coolant cartridge receiver;
storing the heat energy in the coolant cartridge by adding heat energy contained therein; and
removing the coolant cartridge and heat energy stored therein from the coolant cartridge receiver.

10. The method for cooling a battery as claimed in claim 9, further comprising the step of storing heat energy at least partly by a phase transition phenomena of a receiving material arranged in the coolant cartridge.

11. The method for cooling a battery as claimed in claim 9, further comprising the step of arranging the coolant cartridge removed from the coolant cartridge receiver in a refrigeration arrangement for cooling the coolant cartridge.

12. The method for cooling a battery as claimed in claim 11, further comprising the step of reducing the heat energy content of the coolant cartridge by a phase transition phenomena of a receiving material arranged in the coolant cartridge.
